(19) United States
(12) Patent Application Publication
(10) Pub. No.: US 2008/0211738 A1
(43) Pub. Date: Sep. 4, 2008

(54) CHASSIS BASE ASSEMBLY AND DISPLAY APPARATUS INCLUDING THE SAME

(76) Inventors: Hak-Ki Choi, Suwon-si (KR); Sam-Ju Choi, Suwon-si (KR); Meen-Suk Kim, Suwon-si (KR)

Correspondence Address: CHRISTIE, PARKER & HALE, LLP, PO BOX 7068, PASADENA, CA, 91109-7068, US

(21) Appl. No.: 11/752,165

(22) Filed: May 22, 2007

(30) Foreign Application Priority Data
Mar. 2, 2007 (KR) 10-2007-0021157

(51) Int. Cl. G09G 3/28; A47G 29/00

(52) U.S. Cl. 345/60; 248/346.01

(57) ABSTRACT

Provided is a chassis base assembly and a display apparatus including the same. The chassis base assembly includes a chassis base having a plurality of protrusions disposed thereon, the plurality of protrusions extending parallel to each other on the chassis base; and a circuit board disposed on the chassis base between the protrusions and having electronic devices mounted thereon.

### CROSS-REFERENCE TO RELATED PATENT APPLICATIONS

This application claims priority to and the benefit of Korean Patent Application No. 10-2007-0021157, filed on Mar. 2, 2007, in the Korean Intellectual Property Office, the disclosure of which is incorporated herein in its entirety by reference.

### BACKGROUND OF THE INVENTION

1. Field of the Invention

The present invention relates to a chassis base assembly and a display apparatus including the same.

2. Description of the Related Art

Examples of display apparatuses are plasma display panels (PDPs), thin film transistor-liquid crystal displays (TFT-LCDs), organic light emitting diode (OLED) displays, field emission displays (FEDs), and surface-conduction electron-emitter displays (SEDs). PDPs are flat panel display apparatuses for displaying images using a gas discharge, and have some advantages in view of high image quality, slim structure, light weight, wide viewing angle, and large screen size. In addition, plasma display apparatuses can be fabricated in a simple way and can be enlarged easily, and thus, have been considered recently to be most suitable as large flat panel displays.

The plasma display apparatus includes a PDP, a chassis disposed in parallel to the PDP, circuit boards disposed on a rear side of the chassis to drive the PDP, and a case receiving the PDP, the chassis, and the circuit boards. Various kinds of circuit boards, for example, an address electrode driving circuit board, an X electrode driving circuit board, a Y electrode driving circuit board, a power supplying board, and a logic control board, are disposed on the rear side of the chassis. As described above, since a plurality of circuit boards are disposed on the rear side of the chassis, that is, on a limited area, an electromagnetic interference (EMI) can be caused by electromagnetic waves generated from electronic elements mounted on the circuit boards.

### SUMMARY OF THE INVENTION

An exemplary embodiment of the present invention provides a chassis base assembly that shields electromagnetic waves generated by electronic elements mounted on circuit boards, and a display apparatus including the chassis base assembly.

According to an aspect of an exemplary embodiment of the present invention, there is provided a chassis base assembly including: a chassis base having a plurality of protrusions disposed thereon, the plurality of protrusions extending parallel to each other on the chassis base; and a circuit board disposed on the chassis base between the protrusions and having electronic devices mounted thereon.

The chassis base assembly may further include: a cover disposed on the protrusions so as to cover the circuit board.

The cover may include a metal material.

The protrusions may be formed integrally with the chassis base.

The protrusions may be formed separately from the chassis base and may be coupled to the chassis base.

The chassis base may include: a first chassis being substantially flat; and a second chassis having the protrusions formed integrally therewith and disposed on the first chassis.

The circuit board may include a logic control board.

According to another aspect of an exemplary embodiment of the present invention, there is provided a display apparatus including: a display panel displaying images; a chassis base disposed on a rear side of the display panel to support the display panel, the chassis base having a plurality of protrusions disposed thereon, the plurality of protrusions extending parallel to each other on the chassis base; and a circuit board disposed on the chassis base between the protrusions and having electronic devices mounted thereon.

The display apparatus may further include a cover disposed on the protrusions so as to cover the circuit board.

The cover may include a metal material.

The protrusions may be formed integrally with the chassis base.

The protrusions may be formed separately from the chassis base and may be coupled to the chassis base.

The chassis base may include: a first chassis being substantially flat; and a second chassis having the protrusions formed integrally therewith and disposed on the first chassis.

The circuit board may include a logic control board.

The display panel may be a plasma display panel displaying images using a gas discharge.

### BRIEF DESCRIPTION OF THE DRAWINGS

The above and other features and aspects of the present invention will become more apparent by describing in detail exemplary embodiments thereof with reference to the attached drawings in which:

FIG. 1 is a cross-sectional view of a chassis base assembly according to an embodiment of the present invention;

FIG. 2 is a cross-sectional view of a chassis base assembly according to another embodiment of the present invention;

FIG. 3 is a cross-sectional view of a chassis base assembly according to another embodiment of the present invention; and

FIG. 4 is a perspective view of a plasma display apparatus including a chassis base assembly according to an embodiment of the present invention.

### DETAILED DESCRIPTION

The present invention will now be described more fully with reference to the accompanying drawings, in which exemplary embodiments of the invention are shown. A plasma display apparatus will be described as an example of a display apparatus according to the present invention. However, the present invention is not limited thereto, rather the present invention can be applied to any display panel that is supported by a chassis base.

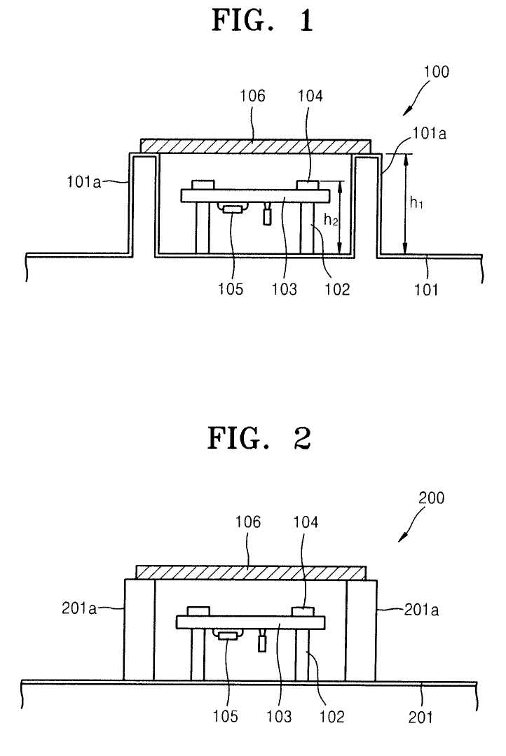

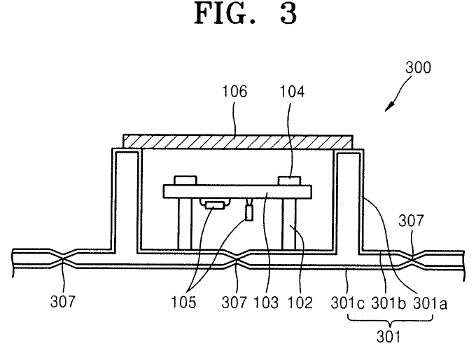

FIG. 1 is a cross-sectional view of a chassis base assembly 100, in which a chassis base 101 and protrusions 101a are formed integrally with each other, according to an embodiment of the present invention. FIG. 2 is a cross-sectional view of a chassis base assembly 200, in which a chassis base 201 and protrusions 201a are separately formed and coupled to each other, according to another embodiment of the present invention. FIG. 3 is a cross-sectional view of a chassis base assembly 300 including a first chassis 301c and a second chassis 301b according to another embodiment of the present invention.

Referring to FIG. 1, the chassis base assembly 100 includes the chassis base 101, a circuit board 103, and a cover 106.

The chassis base 101 supports a plasma display panel (PDP, not shown), and can be fabricated using a casting method or a pressing method. The chassis base 101 can also support other display panels besides PDPs. In one embodiment, the chassis base 101 is formed of a metal having a high thermal conductivity and a high rigidity in order to externally dissipate heat transferred from the PDP and to support the PDP. In other embodiments, the chassis base 101 may be formed of a material that is not conductive, but is light and rigid, such as plastic, for example.

Protrusions 101a are formed to extend from the chassis base 101. Two or more protrusions 101a are formed, and the circuit board 103 is installed on the chassis base 101 in a space formed between a pair of protrusions 101a. That is, the pair of protrusions 101a extend parallel to each other so that the circuit board 103 can be installed therebetween. Since the pair of protrusions 101a are located on both sides of the circuit board 103, electromagnetic waves generated by electronic devices 105 mounted on the circuit board 103 can be shielded. In one embodiment, in order to effectively shield the electromagnetic waves generated by the electronic devices 105 mounted on the circuit board 103, a height h1 of the protrusion 101a is higher than a height h2 of the circuit board 103 from the chassis base 101. In the embodiment depicted in FIG. 1, for example, the height h2 of the circuit board 103 includes the height of bosses 102, the thickness of the circuit board 103, and the thickness of coupling devices 104.

Referring to FIG. 1, the protrusions 101a can be formed integrally with the chassis base 101. In order to form the protrusions 101a integrally with the chassis base 101, a chassis pressing method is used in one embodiment. However, the present invention is not limited thereto. Referring to FIG. 2, in another embodiment, the protrusions 201a are formed separately from the chassis base 201, and are coupled to the chassis base 201. The protrusions 201a can be coupled to the chassis base 201 using a welding method, or using a coupling device such as a screw or a pin.

Referring to FIG. 3, in another embodiment, protrusions 301a are formed using two sheets of chassis 301b and 301c. In FIG. 3, the chassis base 301 includes a first chassis 301c that is substantially flat, and a second chassis 301b including the protrusions 301a. The protrusions 301a on the second chassis 301b can be formed integrally with the second chassis 301b, or can be formed separately from the second chassis 301b and then coupled to the second chassis 301b. In one embodiment, the protrusions 301a that are integrally formed with the second chassis 301b are fabricated using the pressing method, for example. The second chassis 301b, on which the protrusions 301a are formed, is disposed on the first chassis 301c that is substantially flat. The first chassis 301c and the second chassis 301b can be coupled to each other using a rivet, a screw, the TOX® fastening 307 shown in FIG. 3, or any other suitable fastening means. TOX® is a registered trademark of Tox Pressotechnik GMBH, a corporation of Germany. Since the chassis base 301 is formed using the two sheets of the first chassis 301c and the second chassis 301b, a rigidity of the chassis base 301 can be increased.

In addition, the protrusions 101a, 201a, or 301a respectively reinforce the respective chassis bases 101, 201, or 301.

Referring now to FIGS. 1-3, the circuit board 103 disposed on the chassis base 101 includes various electronic devices 105 for driving the PDP, and applies electrical signals for driving the PDP. In one embodiment, the circuit boards 103 used in the plasma display apparatus include an address electrode driving circuit board, an X electrode driving circuit board and a Y electrode driving circuit board, a power supplying board, and a logic control board. The address electrode driving circuit board applies voltage to address electrodes, and the X and Y electrode driving circuit boards apply voltages to X and Y electrodes, respectively. The power supplying board mainly uses a switching mode power supply (SMPS) for reducing sizes and improving efficiency. The logic control board performs calculations and controls required to drive the PDP.

The circuit boards 103 transmit electrical signals to the PDP through signal transmission parts (not shown). In one embodiment, the signal transmission parts are flexible circuit connectors such as tape carrier packages (TCPs) or chip-on-films (COFs). The protrusions 101a, 201a, and 301a can include penetration holes (not shown) for connecting the signal transmission parts to the circuit boards 103. The penetration holes may be formed through side surfaces of the protrusions 101a, 201a, and 301a.

The circuit board 103 can be disposed on the chassis base 101 using the bosses 102 and the coupling devices 104. In more detail, the bosses 102 can be formed on the chassis base 101. The bosses 102 can be formed integrally with the chassis base 101, or can be formed separately from the chassis base 101 and coupled to the chassis base 101. A hole can be formed (not shown) in each of the bosses 102, and a screw tap can be formed on an inner circumferential surface of the hole. Accordingly, a screw tap can be formed on an outer circumferential surface of each of the coupling devices 104. In addition, penetration holes (not shown) can be formed in the circuit board 103. The circuit board 103 can be coupled to the chassis base 101 using the coupling devices 104 connecting the penetration holes of the circuit board 103 to the holes of the bosses 102. The present invention is not limited thereto, and other coupling devices that can connect the circuit board 103 to the chassis base 101 can be used.

In the embodiments illustrated in FIGS. 1-3, the circuit board 103 is disposed on the chassis base 101, a surface of the circuit board 103, on which the electronic devices 105 are mounted, faces the chassis base 101. Therefore, the electromagnetic waves generated by the electronic devices 105 can be shielded. In addition, since the electronic devices 105 are not exposed, they can be protected from external shocks.

A cover 106 can be disposed on the pair of protrusions 101a, 201a, or 301a. As described above, the circuit board 103 is disposed between the protrusions 101a, 201a, or 301a, and thus, the electromagnetic waves generated by the electronic devices 105 mounted on the circuit board 103 can be shielded. In addition, when the cover 106 is disposed on the pair of protrusions 101a, 201a, or 301a, the electromagnetic waves emitted toward a rear side of the circuit board 103 can also be effectively shielded. The cover 106 and the protrusions 101a, 201a, or 301a can be coupled to each other using a coupling device such as a screw or a pin, or using a welding method. In addition, an end portion of the cover 106 can be coupled to at least one of the protrusions 101a, 201a, or 301a using a hinge so that the cover 106 can be lifted about the hinge. The present invention is not limited thereto, and the cover 106 and the protrusions 101a, 201a, or 301a can be coupled to each other using other coupling units or devices. The cover 106 can be formed of metal.

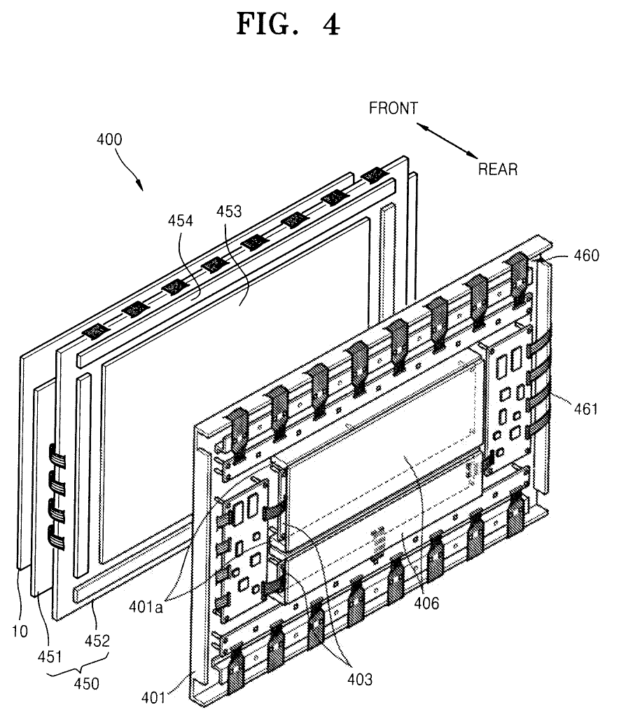

FIG. 4 is a perspective view of a plasma display apparatus 400 including the chassis base assembly according to an embodiment of the present invention.

Referring to FIG. 4, the plasma display apparatus 400 includes a PDP 450, a chassis base 401, and circuit boards 403. In the embodiment illustrated in FIG. 4, a filter 10, such as a contrast enhancing film (CEF), is attached on a front surface of the PDP 450. An adhesive component such as dual-adhesive tape 454 can be used to couple the PDP 450 and the chassis base 401 to each other. In one embodiment, a thermal conductor 453 is disposed between the chassis base 401 and the PDP 450 in order to dissipate heat generated by the PDP 450 through the chassis base 401.

The PDP 450 displays images using a gas discharge, and includes a front substrate 451 and a rear substrate 452 coupled to each other. Discharge cells which are partitioned by barrier ribs (not shown) are formed between the front and rear substrates 451 and 452, and a discharge gas is filled in the discharge cells. In addition, a phosphor material is applied in the discharge cells.

A plurality of address electrodes (not shown) are disposed parallel to each other on the rear substrate 452, and sustain electrode pairs (not shown) are disposed in a direction crossing the address electrodes on the front substrate 451. When a discharge occurs in the discharge gas between the electrodes due to the voltages applied to the electrodes, the phosphor material is excited by ultraviolet rays generated due to the discharge of the discharge gas to emit light and display images.

The chassis base 401 is disposed on a rear side of the PDP 450 in order to structurally support the PDP 450. The chassis base 401 may be formed of a metal having a high rigidity, for example, aluminum or steel, or a plastic material.

The thermal conductor 453 is disposed between the PDP 450 and the chassis base 401. In addition, a plurality of strips of dual-adhesive tape 454 are disposed on portions of the rear substrate 452 out with an edge of the thermal conductor 453, and the strips of dual-adhesive tape 454 fix the PDP 450 and the chassis base 401 to each other.

In addition, the circuit boards 403 are disposed on the rear side of the chassis base 401, and the circuit boards 403 include circuits for driving the PDP 450. The circuit boards 403 transmit the electrical signals to the PDP 450 using signal transmission parts. By way of example, flexible printed cables (FPCs), TCPs, or COFs can be used as the signal transmission parts. According to the current embodiment, FPCs 461 are disposed on left and right sides of the chassis base 401 as signal transmission parts, and TCPs 460 are disposed on upper and lower portions of the chassis base 401 as signal transmission parts.

As shown in FIG. 4, protrusions 401a extending parallel to each other are formed along sides of each of the circuit boards 403 disposed on the rear side of the chassis base 401. In addition, covers 406 are disposed over the respective circuit boards 403 installed on the protrusions 401a. Since the protrusions 401a are located on both sides of the circuit boards 403 and the covers 406 are disposed on the circuit boards 403, electromagnetic waves generated by the electronic devices mounted on the circuit boards 403 can be effectively shielded.

The chassis base assembly according to the described embodiments of the present invention is applied to the plasma display apparatus, however, the chassis base assembly according to the described embodiments of the present invention can also be applied to various other types of display apparatuses.

In the chassis base assembly according to the described embodiments of the present invention, the circuit board is disposed between the protrusions formed on the chassis base, and thus, the electromagnetic waves generated by the circuit board can be shielded and electromagnetic interference can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A chassis base assembly comprising:
a chassis base having a plurality of protrusions disposed thereon, the plurality of protrusions extending parallel to each other on the chassis base; and
a circuit board disposed on the chassis base between the protrusions and having electronic devices mounted thereon.

2. The chassis base assembly of claim 1, further comprising:
a cover disposed on the protrusions so as to cover the circuit board.

3. The chassis base assembly of claim 2, wherein the cover comprises a metal material.

4. The chassis base assembly of claim 1, wherein the protrusions are formed integrally with the chassis base.

5. The chassis base assembly of claim 1, wherein the protrusions are formed separately from the chassis base and are coupled to the chassis base.

6. The chassis base assembly of claim 1, wherein the chassis base includes:
a first chassis being substantially flat; and
a second chassis having the protrusions formed integrally therewith and disposed on the first chassis.

7. The chassis base assembly of claim 1, wherein the circuit board comprises a logic control board.

8. The chassis base assembly of claim 1, wherein a surface of the circuit board, on which the electronic devices are mounted, faces the chassis base.

9. A display apparatus comprising:
a display panel for displaying images;
a chassis base disposed on a rear side of the display panel to support the display panel, the chassis base having a plurality of protrusions disposed thereon, the plurality of protrusions extending parallel to each other on the chassis base; and
a circuit board disposed on the chassis base between the protrusions and having electronic devices mounted thereon.

10. The display apparatus of claim 9, further comprising:
a cover disposed on the protrusions so as to cover the circuit board.

11. The display apparatus of claim 10, wherein the cover comprises a metal material.

12. The display apparatus of claim 9, wherein the protrusions are formed integrally with the chassis base.

13. The display apparatus according to claim 12, wherein the display panel is a plasma display panel for displaying images using a gas discharge.

14. The display apparatus of claim 9, wherein the protrusions are formed separately from the chassis base and are coupled to the chassis base.

15. The display apparatus according to claim 9, wherein the display panel is a plasma display panel for displaying images using a gas discharge.

16. The display apparatus of claim 9, wherein the chassis base comprises:
a first chassis being substantially flat; and
a second chassis having the protrusions formed integrally therewith and disposed on the first chassis.

17. The display apparatus according to claim 9, wherein the display panel is a plasma display panel for displaying images using a gas discharge.

18. The display apparatus of claim 9, wherein the circuit board comprises a logic control board.

19. The display apparatus of claim 9, wherein a surface of the circuit board, on which the electronic devices are mounted, faces the chassis base.

20. The display apparatus according to claim 9, wherein the display panel is a plasma display panel for displaying images using a gas discharge.
